(19) United States
(12) Patent Application Publication
(10) Pub. No.: US 2021/0095764 A1
(43) Pub. Date: Apr. 1, 2021

(54) SEALING ARRANGEMENT FOR SEALING A PART WITH A SEALING SURFACE, METHOD OF SEALING A SEALING SURFACE OF A PART

(71) Applicant: TE Connectivity Belgium BVBA, Oostkamp (BE)

(72) Inventor: Jorgen Vervaet, Oostkamp (BE)

(73) Assignee: TE Connectivity Belgium BVBA, Oostkamp (BE)

(21) Appl. No.: 17/004,883

(22) Filed: Aug. 27, 2020

(30) Foreign Application Priority Data
Sep. 27, 2019 (EP) 19200052.9

(51) Int. Cl. F16J 15/08

(52) U.S. Cl. CPC F16J 15/0818; F16J 2015/0856

(57) ABSTRACT

A sealing arrangement for sealing a part with a sealing surface includes an adhesive member and a seal contacting plate sealingly attached to the sealing surface by the adhesive member.

### CROSS-REFERENCE TO RELATED APPLICATION

This application claims the benefit of the filing date under 35 U.S.C. § 119(a)-(d) of European Patent Application No. 19200052.9, filed on Sep. 27, 2019.

### FIELD OF THE INVENTION

The invention relates to a sealing arrangement and, more particularly, to a sealing arrangement for sealing a part at a sealing surface.

### BACKGROUND

A part with a sealing surface can, for example, be a housing made from aluminum to which a connector or a sensor is attached. When the connector is attached at the sealing surface with a seal, such a connection often does not withstand extended salt spray cycles. Liquid can then get into the interior of the housing and damage components therein.

### SUMMARY

A sealing arrangement for sealing a part with a sealing surface includes an adhesive member and a seal contacting plate sealingly attached to the sealing surface by the adhesive member.

### BRIEF DESCRIPTION OF THE DRAWINGS

The invention will now be described by way of example with reference to the accompanying Figures, of which:

FIG. 1 is a perspective view of a sealing arrangement and a part with a sealing surface;

FIG. 2 is a perspective view of the sealing arrangement attached to the part;

FIG. 3 is a sectional side view of the sealing arrangement attached to the part with a connector; and

FIG. 4 is a sectional side view of an adhesive member of the sealing arrangement.

### DETAILED DESCRIPTION OF THE EMBODIMENT(S)

In the following, the invention and its improvements are described in greater detail using exemplary embodiments and with reference to the drawings. The described embodiments are only possible configurations in which, however, the individual features as described herein can be provided independently of one another, or can be omitted. In the following figures, elements having the same function and/or the same structure will be referenced by the same reference signs.

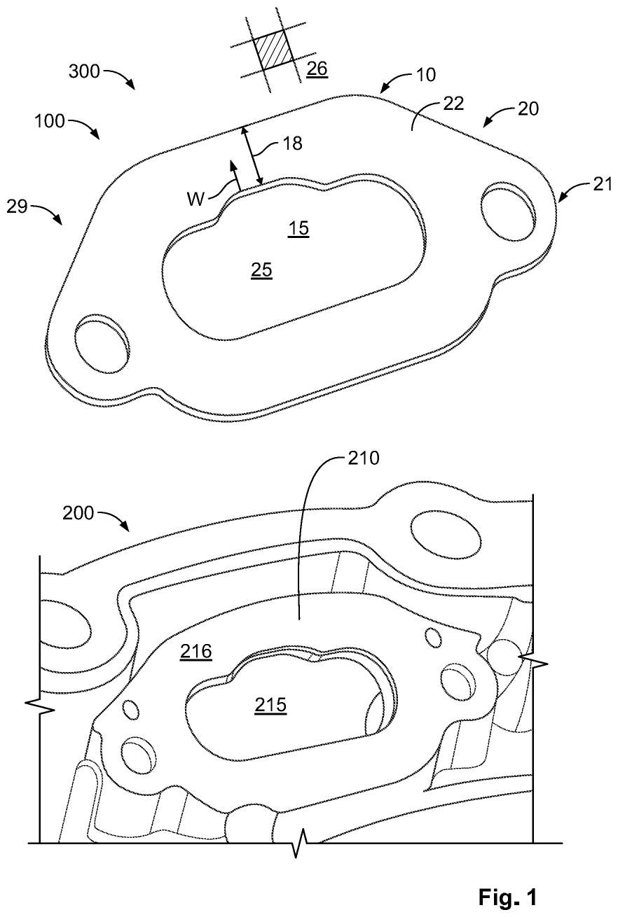

A sealing arrangement 100 according to an embodiment is shown in FIGS. 1-3. The sealing arrangement 100 is used to seal a part 200 at a sealing surface 210 of the part 200, for example when a connector 50 is attached. In an embodiment, a sealing assembly 300 includes the sealing arrangement 100 and the part 200 with the sealing surface 210.

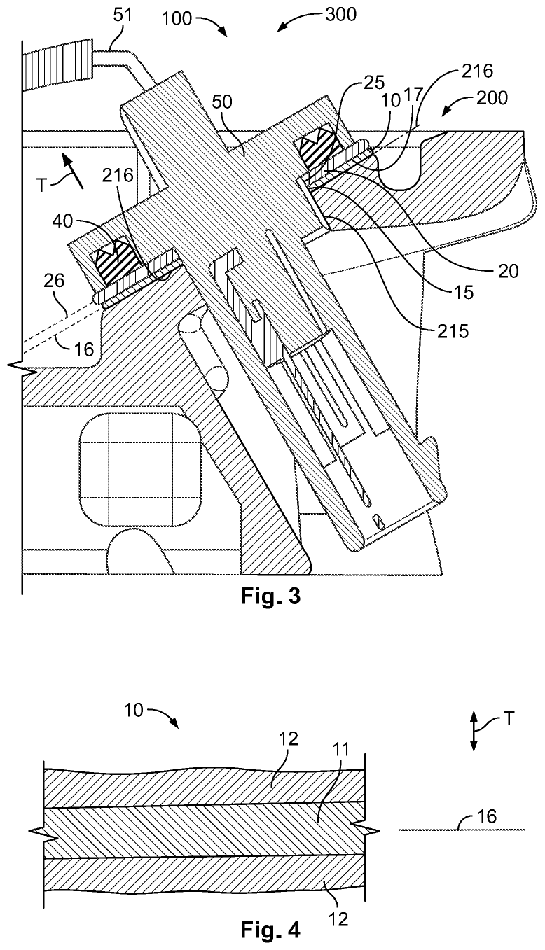

If the connector 50, shown in FIG. 3, would be attached without the sealing arrangement 100, a seal 40 of the connector 50 would be in direct contact with the sealing surface 210. Such a connection would, however, start leaking under certain repeated environmental conditions, which can be simulated by standardized tests, for example in a salt spray test in which salt water is repeatedly sprayed onto the connection. This problem is pronounced when certain materials are used for the sealing surface 210 and/or the part 200, for example aluminum or an aluminum alloy.

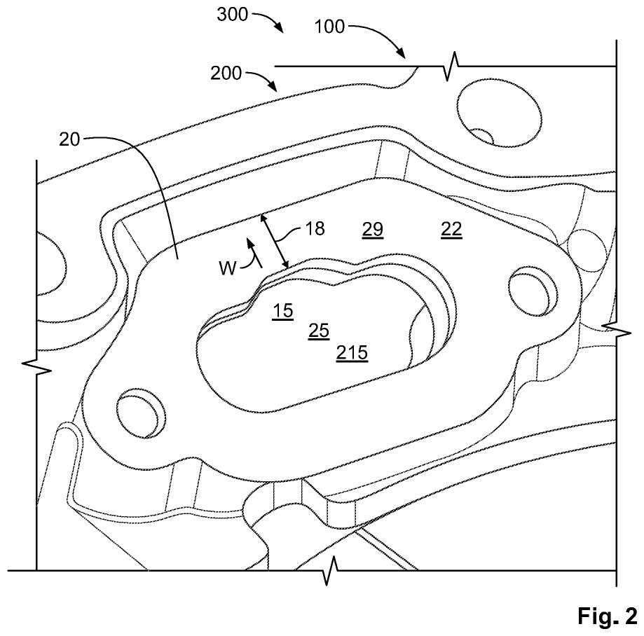

The sealing arrangement 100 helps to keep the connection tight even under difficult conditions. The sealing arrangement 100, as shown in FIGS. 1, 3, and 4, includes an adhesive member 10 and a seal contacting plate 20. The seal contacting plate 20 is adapted to be sealingly attached to the sealing surface 210 shown in FIG. 2 by the adhesive member 10. In FIG. 1, the adhesive member 10 is attached to the nonvisible side of the seal contacting plate 20. The combination of the adhesive member 10 and the seal contacting plate 20 is then attached to the sealing surface 210 of the part 200, as shown in FIG. 3.

The adhesive member 10 thus has a dual function. On the one hand, it attaches the seal contacting plate 20 to the sealing surface 210. On the other hand, it provides a sealing function between the seal contacting plate 20 and the sealing surface 210.

A front surface 22 of the seal contacting plate 20 faces in the mounted state in the same direction as the sealing surface 210 of the part 200, as shown in FIGS. 1 and 2. The front surface 22 can thus replace the sealing surface 210. The front surface 22 can have better physical properties than the sealing surface 210. For example, the front surface 22 can be smoother and/or can expose a different material that is less prone to corrosion. The seal contacting plate 20 can be made from a corrosion resistant material, for example stainless steel or a plastic material.

As shown in FIG. 4, the adhesive member 10 has a flexible carrier structure 11. The flexible carrier structure 11 can, for example, comprise a film made from a plastic material, a rubber material, or other flexible structures like paper or thin metal foils. In an embodiment, the flexible carrier structure 11 is a planar to simplify the application and result in a good sealing performance.

On both sides of the flat and planar flexible carrier structure 11, adhesive 12 is located. The adhesive 12 can be gel-like and for example be curable. For example, the adhesive 12 can harden when the seal contacting plate 20 has been attached to the sealing surface 210. Thus, a rough surface can be sealed properly and permanently. The adhesive member 10 can in particular comprise or be a double-sided adhesive tape 17 as shown in the embodiment of FIG. 3 that can, for example, be readily available on the market.

The seal contacting plate 20 can, in particular, comprise a sheet metal 21, as shown in FIG. 1. In an embodiment, the seal contacting plate 20 can then be produced by punching or stamping. This can, in particular, be done when the sheet metal 21 is already attached to a strip-shaped tape that later forms the adhesive member 10. During the production, these two flat elements can be attached to each other and the combination of the seal contacting plate 20 and the adhesive member 10 can then be cut out from this combination. In another embodiment, the seal contacting plate 20 is a foil. Such a seal contacting plate 20 can be more flexible than one with sheet metal 21.

In other embodiments, the adhesive member 10 can be applied to the sealing surface 210 of the part 200 first. In a subsequent step, the seal contacting plate 20 can then be attached.

As shown in FIG. 1, the seal contacting plate 20 forms a frame 29 and has a closed frame structure that surrounds an opening 25. This opening 25 is aligned with an opening 15 in the adhesive member 10 and in the mounted state also aligned with an opening 215 on the part 200, as shown in FIGS. 1 and 2. This opening 215 can allow the connector 50 to protrude into the part 200, as shown in FIG. 3. The connector 50 is shown at the end of a cable 51 in FIG. 3.

A plane 16 of the adhesive member 10 is parallel to a plane 26 of the seal contacting plate 20 and the plane 216 of the sealing surface 200 in the mounted state, as shown in FIG. 3, in order to achieve a compact configuration. In the mounted state, an adhesive surface of the adhesive member 10 faces in a direction perpendicular to the plane 16 of the opening 15. The adhesive member 10 can be compressible, in particular elastically compressible, for example in a thickness direction T that is perpendicular to the plane 16 of the adhesive member 10. This increases the sealing effect.

The adhesive member 10, in an embodiment shown in FIGS. 1 and 2, can have a width 18 in a width direction W lying in the plane 16, the width 18 being greater than a size of cavities or casting voids in the part 200. The adhesive member 10 can then cover the cavities in their entire width. The cavities can be casting voids that are formed when the cast part 200 shrinks. The size of the cavities that is compared to the width 18 of the adhesive member 10 can, in particular, be a maximum size that is usually formed for certain casting conditions. In an embodiment, the width 18 is at least three, especially five times greater than the size of cavities or casting voids in the part 200; by this, the cavity cannot have a negative influence on the sealing performance.

What is claimed is:

1. A sealing arrangement for sealing a part with a sealing surface, comprising:
an adhesive member; and
a seal contacting plate sealingly attached to the sealing surface by the adhesive member.

2. The sealing arrangement of claim 1, wherein the adhesive member has a flexible carrier structure.

3. The sealing arrangement of claim 2, wherein the flexible carrier structure is planar.

4. The sealing arrangement of claim 1, wherein the adhesive member is a double-sided adhesive tape.

5. The sealing arrangement of claim 1, wherein the seal contacting plate is made from a corrosion resistant material.

6. The sealing arrangement of claim 1, wherein the seal contacting plate is a sheet metal.

7. The sealing arrangement of claim 1, wherein the seal contacting plate surrounds an opening.

8. The sealing arrangement of claim 1, wherein an adhesive surface of the adhesive member faces in a direction perpendicular to a plane of the opening.

9. The sealing arrangement of claim 1, wherein the adhesive member is compressible.

10. The sealing arrangement of claim 1, wherein the sealing surface is an aluminum surface.

11. A sealing assembly, comprising:
a part with a sealing surface; and
a sealing arrangement including an adhesive member and a seal contacting plate sealingly attached to the sealing surface by the adhesive member.

12. The sealing assembly of claim 11, wherein the sealing surface has a plurality of cavities.

13. The sealing assembly of claim 12, wherein the adhesive member has a width greater than the cavities.

14. The sealing assembly of claim 11, wherein the sealing surface is an aluminum surface.

15. A method of sealing a sealing surface of a part, comprising:
applying a seal contacting plate with an adhesive member to the sealing surface.

16. The method of claim 15, wherein the adhesive member is applied to the seal contacting plate before the seal contacting plate is applied to the sealing surface.

17. The method of claim 15, wherein the adhesive member is applied to a sheet metal and the seal contacting plate is cut from the sheet metal.

18. The method of claim 15, wherein the sealing surface is an aluminum surface.
